(19) United States
(12) Patent Application Publication
(10) Pub. No.: US 2005/0216385 A1
(43) Pub. Date: Sep. 29, 2005

(54) Method, system, and computer useable medium to determine remaining financial obligations of assets

(76) Inventor: Gary N. Schneider, Northbrook, IL (US)

Correspondence Address: Richard C. Litman;LITMAN LAW OFFICES, LTD., P.O. Box 15035, Arlington, VA, 22215, US

(21) Appl. No.: 10/765,111

(22) Filed: Jan. 28, 2004

(51) Int. Cl. G06F 17/60

(52) U.S. Cl. 705/35

(57) ABSTRACT

A method, system, and/or computer useable medium to determine remaining financial obligations of assets. ASSET FINANCIAL RESTRUCTURING software is executed to determine the remaining financial obligations of leased assets and the book value of financed or depreciated assets utilizing data from primary data, data from stored data, and manually input data. Determinations are made for an asset for a TERM USED in months, a TERM REMAINING, a MINIMUM TERM REMAINING, a MAXIMUM TERM REMAINING, an AVERAGE TERM, an ESTIMATED RESIDUAL VALUE, an UPLIFTED RESIDUAL VALUE, a TERMINATION VALUE, a FINANCE RATE, and a REMAINING BOOK VALUE. Finally, a TOTAL REMAINING OBLIGATION is determined for the asset.

### BACKGROUND OF THE INVENTION

1. Field of the Invention

The present invention generally relates to assets and, more particularly, to a method, system, and/or computer useable medium to determine remaining financial obligations of assets.

2. Description of the Related Art

Technology leases are widely used by businesses of all shapes, sizes, and specialties because they enable such businesses to evaluate and acquire technologies without the worries of capital-crunching expenditures. Technology leases are offered by hardware and software manufacturers as well as from resellers, and typically include such items as monitors, printers, computers, servers, routers, computer and/or network configuration, administration, maintenance, etc. At the end of most technology leases, the lessee is able to purchase the hardware and software at the current fair market value, extend the lease on a month-to-month basis, return the hardware and software, or renew the lease for a fixed period.

However, if the lessee wishes to terminate a technology lease before the expiration of the lease, it is currently difficult for the lessee to determine the cost of the early termination of lease obligations. This information is currently not published, nor is it readily available except from the lessor. The lessor is not obligated to provide a quote that allows the lessee to terminate the lease. Refusal to provide a lease termination may damage the business relationship, causing many lessors to acquiesce. Should the lessor agree to allow an early termination of the lease contract, the lessor is motivated to quote a high number in order to maximize the financial gain from the contract. Obtaining a quote from the lessor many times takes several days or weeks to complete.

The lessee may need this information for purposes other than actually terminating a lease. When preparing annual budgets, financial managers will many times attempt to optimize the use of funds allocated to capital and expense categories. Many times a lease is considered in the expense budget in order to achieve certain financial goals. Knowing the cost to terminate an existing lease helps corporate financial planners determine if it is advantageous to purchase the leased asset and capitalize it, return the leased assets and purchase an alternate, or continue with the lease per the lease contract.

Knowing the cost to early terminate a lease can also assist a company in evaluating other alternatives that newer technologies may provide. Technology innovation has proven over the past four decades that newer products can do more while costing the same or less. Gordon Moore of Intel Corporation theorized in 1965 that the number of transistors per circuit would grow exponentially every one to three years (“Moore's Law”). This phenomenon has occurred and is expected to continue for the foreseeable future. To the degree that newer technology can benefit businesses, it is prudent that they find ways to use it. The timetable to achieve the greatest benefit in deploying technology may not coincide with existing lease obligations, hence the need to evaluate the business impact of early lease termination.

Early termination costs for technology leases can also be used by the sellers of technology in order to determine the optimal times to refresh installed assets. This information, even if estimated, provides the basis for improved bilateral negotiations of the lease termination. Lessees gain insight into lessor costs associated with such an event, causing lessors to be more inclined to cooperate with the process. These are but a few of the applications where this information can be used, provided it becomes easy and timely to obtain.

As such a need exists to provide a method, system, and/or computer useable medium to determine remaining financial obligations of assets. The related art is represented by the following references of interest.

U.S. patent application Publication No. 2002/0178100 A1, published on Nov. 28, 2002 for Paula Koveos, describes an asset performance management system to link asset suppliers, asset users, and an asset manager. The Koveos application does not suggest a method, system, and/or computer useable medium to determine remaining financial obligations of assets according to the claimed invention.

U.S. patent application Publication No. 2003/0055749 A1, published on Mar. 20, 2003 for Cora L. Carmody et al., describes a life cycle process to develop and monitor the processes and metrics to perform the orderly planning, acquisition, entry use, insight, refresh, and retirement of all information technology assets. The Carmody et al. application does not suggest a method, system, and/or computer useable medium to determine remaining financial obligations of assets according to the claimed invention.

U.S. patent application Publication No. 2003/0088456 A1, published on May 8, 2003 for L. Mark Ernest et al., describes a system and process for managing an information technology infrastructure which collects transaction information on a component basis. The Ernest et al. application does not suggest a method, system, and/or computer useable medium to determine remaining financial obligations of assets according to the claimed invention.

U.S. patent application Publication No. 2003/0088489 A1, published on May 8, 2003 for Dirk Peters et al., describes a web-based investment advisory system and method to assist financial advisors in delivering personalized investment advisory services to investors. The Peters et al. application does not suggest a method, system, and/or computer useable medium to determine remaining financial obligations of assets according to the claimed invention.

U.S. patent application Publication No. 2003/0093352 A1, published on May 15, 2003 for Sanjay P. Muralidhar et al., describes a method, apparatus, and program for evaluating financial trading strategies and portfolios for evaluating financial trading strategies and portfolios. The Muralidhar et al. application does not suggest a method, system, and/or computer useable medium to determine remaining financial obligations of assets according to the claimed invention.

U.S. patent application Publication No. 2003/0154199 A1, published on Aug. 14, 2003 for Shawn Thomas et al., describes a method and system for integrated asset management. The Thomas et al. application does not suggest a method, system, and/or computer useable medium to determine remaining financial obligations of assets according to the claimed invention.

U.S. patent application Publication No. 2003/0158800 A1, published on Aug. 21, 2003 for Thomas Pisello et al., describes methods and an apparatus for financial evaluation of information technology projects. The Pisello et al. application does not suggest a method, system, and/or computer useable medium to determine remaining financial obligations of assets according to the claimed invention.

U.S. patent application Publication No. 2003/0167217 A1, published on Sep. 4, 2003 for Vincent Formale et al., describes a method and apparatus for capitalizing assets. The Formale et al. application does not suggest a method, system, and/or computer useable medium to determine remaining financial obligations of assets according to the claimed invention.

U.S. patent application Publication No. 2003/0187707 A1, published on Oct. 2, 2003 for Stefan Hack et al., describes a business process analysis tool the derives relevant business processes. The Hack et al. application does not suggest a method, system, and/or computer useable medium to determine remaining financial obligations of assets according to the claimed invention.

U.S. patent application Publication No. 2003/0187874 A1, published on Oct. 2, 2003 for Andreas Peschel et al., describes a portfolio creation and management tool that creates and manages a portfolio of intellectual property assets of a global entity having sub-entities located in various localities around the world. The Peschel et al. application does not suggest a method, system, and/or computer useable medium to determine remaining financial obligations of assets according to the claimed invention.

U.S. Pat. No. 4,739,478, issued on Apr. 19, 1988 for Peter A. Roberts et al., describes methods and apparatus for restructuring one or more debt obligations issued in the form of interest-bearing bonds into a serial issue of zero coupon bonds. The Roberts et al. patent does not suggest a method, system, and/or computer useable medium to determine remaining financial obligations of assets according to the claimed invention.

U.S. Pat. No. 5,884,287, issued on Mar. 16, 1999 for Michael Edesess, describes a system and method for generating and displaying risk and return in an investment portfolio. The Edesess patent does not suggest a method, system, and/or computer useable medium to determine remaining financial obligations of assets according to the claimed invention.

U.S. Pat. No. 6,003,018, issued on Dec. 14, 1999 for Richard O. Michaud et al., describes a method for evaluating an existing or putative portfolio having a plurality of assets. The Michaud et al. patent does not suggest a method, system, and/or computer useable medium to determine remaining financial obligations of assets according to the claimed invention.

U.S. Pat. No. 6,078,904, issued on Jun. 20, 2000 for George J. Rebane, describes methods and software products for investment portfolio design and the selection, analysis of investments, and the allocation of investment assets among investments. The Rebane patent does not suggest a method, system, and/or computer useable medium to determine remaining financial obligations of assets according to the claimed invention.

U.S. Pat. No. 6,366,916 B1, issued on Apr. 2, 2002 for William J. Baer et al., describes a configurable and extensible system for deploying asset management functions to client applications. The Baer et al. patent does not suggest a method, system, and/or computer useable medium to determine remaining financial obligations of assets according to the claimed invention.

U.S. Pat. No. 6,430,542 B1, issued on Aug. 6, 2002 for William J. Moran, describes a financial planning and advice system that allows an advisor to provide proactive, efficient service to clients. The Moran patent does not suggest a method, system, and/or computer useable medium to determine remaining financial obligations of assets according to the claimed invention.

U.S. Pat. No. 6,453,303 B1, issued on Sep. 17, 2002 for Bin Li, describes a system for automatically generating and displaying market analysis related to assets whereby the analysis for substantially all assets. The Li patent does not suggest a method, system, and/or computer useable medium to determine remaining financial obligations of assets according to the claimed invention.

U.S. Pat. No. 6,581,045 B1, issued on Jun. 17, 2003 for James R. Watson, describes an asset management system for analyzing the condition of assets and evaluating repair/replacement options. The Watson patent does not suggest a method, system, and/or computer useable medium to determine remaining financial obligations of assets according to the claimed invention.

Japan Patent Application Publication No. 9-81640, published on Mar. 28, 1997, describes a scenario retrieval processing method in risk analysis of assets. The Japan '640 application does not suggest a method, system, and/or computer useable medium to determine remaining financial obligations of assets according to the claimed invention.

Japan Patent Application Publication No. 2002-203104, published on Jul. 19, 2002, describes a method, system, and program for supporting management of assets and liabilities. The Japan '104 application does not suggest a method, system, and/or computer useable medium to determine remaining financial obligations of assets according to the claimed invention.

Japan Patent Application Publication No. 2003-85373, published on Mar. 20, 2003, describes an asset and liability management device and method for an insurance company. The Japan '373 application does not suggest a method, system, and/or computer useable medium to determine remaining financial obligations of assets according to the claimed invention.

Japan Patent Application Publication No. 2003-91637, published on Mar. 28, 2003, describes a fixed asset information management system. The Japan '637 application does not suggest a method, system, and/or computer useable medium to determine remaining financial obligations of assets according to the claimed invention.

None of the above references, taken either singly or in combination, is seen to describe the instant invention as claimed. Thus a method, system, and/or computer useable medium to determine remaining financial obligations of assets solving the aforementioned problems is desired.

### SUMMARY OF THE INVENTION

The present invention is a method, computer useable medium, and/or system to determine remaining financial obligations of assets. ASSET FINANCIAL RESTRUCTURING software is executed to determine the remaining financial obligations of leased assets and the book value of financed or depreciated assets utilizing data from primary data files, preliminary data, stored data, and manually input data. A TERM USED in months is determined for an asset. A TERM REMAINING for the asset is determined. A MINIMUM and MAXIMUM TERM REMAINING for the asset is determined. An AVERAGE TERM for the asset is determined. An ESTIMATED RESIDUAL VALUE for the asset is determined. An UPLIFTED RESIDUAL VALUE for the asset is determined. A TERMINATION VALUE for the asset is determined. A FINANCE RATE for the asset is determined. A REMAINING BOOK VALUE for the asset is determined. Finally, a TOTAL REMAINING OBLIGATION for the asset is determined.

Accordingly, it is a principal aspect of the invention to provide a method, system, and/or computer useable medium that executes ASSET FINANCIAL RESTRUCTURING software to determine remaining financial obligations of assets. Data is utilized from primary data files, preliminary data, stored data, and manually input data. The remaining financial obligation value of leased assets and the book value of financed or depreciated assets are then determined.

It is another aspect of the invention to provide a method, system, and/or computer useable medium to determine remaining financial obligations of assets where a TERM REMAINING for an asset is determined, a MINIMUM and MAXIMUM TERM REMAINING for the asset is determined, an AVERAGE TERM for the asset is determined, an ESTIMATED RESIDUAL VALUE for the asset is determined, an UPLIFTED RESIDUAL VALUE for the asset is determined, a TERMINATION VALUE for the asset is determined, a FINANCE RATE for the asset is determined, a REMAINING BOOK VALUE for the asset is determined, and a TOTAL REMAINING OBLIGATION for the asset is determined.

It is an aspect of the invention to provide improved elements and arrangements thereof in a method, system, and/or computer useable medium to determine remaining financial obligations of assets for the purposes described which is inexpensive, dependable, and fully effective in accomplishing its intended purposes.

These and other aspects of the present invention will become readily apparent upon further review of the following specification and drawings.

### BRIEF DESCRIPTION OF THE DRAWINGS

FIG. 1 is a block diagram of a computing device configured with ASSET FINANCIAL RESTRUCTURING software to determine remaining financial obligations of assets according to the present invention.

FIG. 2 is a flow chart of the procedure executed by ASSET FINANCIAL RESTRUCTURING software to determine remaining financial obligations of assets according to the invention.

FIGS. 3A and 3B show primary data files utilized by ASSET FINANCIAL RESTRUCTURING software to determine remaining financial obligations of assets.

FIG. 4 shows preliminary data and stored data utilized by ASSET FINANCIAL RESTRUCTURING software to determine remaining financial obligations of assets.

FIG. 5 shows manually entered data utilized by ASSET FINANCIAL RESTRUCTURING software to determine remaining financial obligations of assets.

Similar reference characters denote corresponding features consistently throughout the attached drawings.

### DETAILED DESCRIPTION OF THE PREFERRED EMBODIMENTS

The present invention is a method, system, and/or computer useable medium to determine remaining financial obligations of assets. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

Determining the remaining financial obligations of assets according to the invention involves the layering of several simultaneous computations in order to arrive at the result. These computations are performed with inventive ASSET FINANCIAL RESTRUCTURING software developed according to the invention. Some basic data is needed before the inventive procedure is initiated. Such data includes the lease date, lease term, lease payment, original equipment amount, and the actual or estimated cost of funds used in determining the lease payment for a particular asset.

The ASSET FINANCIAL RESTRUCTURING software initially computes the REMAINING TERM for an asset. A formula compares the current date with the lease start date of the asset, and subtracts the result from the original lease term. By using the computer system date as the current date, the ASSET FINANCIAL RESTRUCTURING software causes the remaining term to be automatically updated on a daily basis.

The ASSET FINANCIAL RESTRUCTURING software then estimates the RESIDUAL VALUE (equity investment placed in the transaction by the lessor) used in developing the lease payment for an asset. The lease term, lease payment, cost of funds, and original equipment is used to determine the RESIDUAL VALUE of the asset.

Repayment of the residual value is fundamental to lessor consideration of an early termination of technology leases for a number of reasons. The effects of Moore's Law include steadily declining used equipment values as new, more cost-effective technology obsoletes previous products. In a non-technology lease, the market value may from time-to-time actually exceed the residual value, making it more advantageous for the lessor to reclaim and resell the equipment. This situation is rare in technology leases. This fact should cause lessors to be conservative in setting residual values, however doing this would result in a higher lease rate, reducing its competiveness and jeopardizing the ability to win the transaction. Therefore, residual values set by the lessor at lease commencement are intended to approximate what these future values will be.

Another reason why lessors prefer not to accept asset returns from an early lease termination is the burden of remarketing equipment ahead of a scheduled return date. This burden includes the loss of remarketing lead time, which increase inventory and warehouse expenses. One potential offset occurs when current market values exceed the residual which was calculated to be the value at a future date. This situation is not known until the actual time of the termination and presents both an opportunity and risk that most lessors would prefer to avoid altogether. Given these factors, a lessor is more included to accept the return of their investment, rather than the return of the assets.

Estimating the residual value is only a part of the requirement. There is significant risk assumed by the lessor in placing equity into a transaction that may or may not be repaid, contingent on the market value of the equipment at the end of the lease. In order to justify such investments and risk, the lessor requires an above-average gain on their investment to compensate for those investments which result in no gain or loss. It is important to note that lessor risk is not limited to the amount of investment in a transaction. Other risks include bad debt and collection expense, expenses to confiscate and reclaim the assets, as well as shipping and disposal costs. Because of these other business risks, above-average returns are expected in lease transactions that are performing in order to compensate for those that are not performing.

The ASSET FINANCIAL RESTRUCTURING software then takes the estimated residual value and increases it to provide a return to the lessor commensurate with the risk of its investment in the transaction. The amount of increase acceptable to the lessor is subject to negotiation. Therefore, the ASSET FINANCIAL RESTRUCTURING software provides a number of alternative methods to calculate the results, including a table of uplift percentages, a constant percentage used for all calculations, and other customized approaches that support the lessee/lessor relationship.

Once this value is determined, it is utilized by the ASSET FINANCIAL RESTRUCTURING software to determine the present value of the asset over the remaining term, by combining this result with the present value of the remaining lease payments. The remaining lease term, lease payment, the actual or estimated cost of funds used in determining the lease payment, and the uplifted residual value from previous calculations are used for determining the present value of the asset over the remaining term.

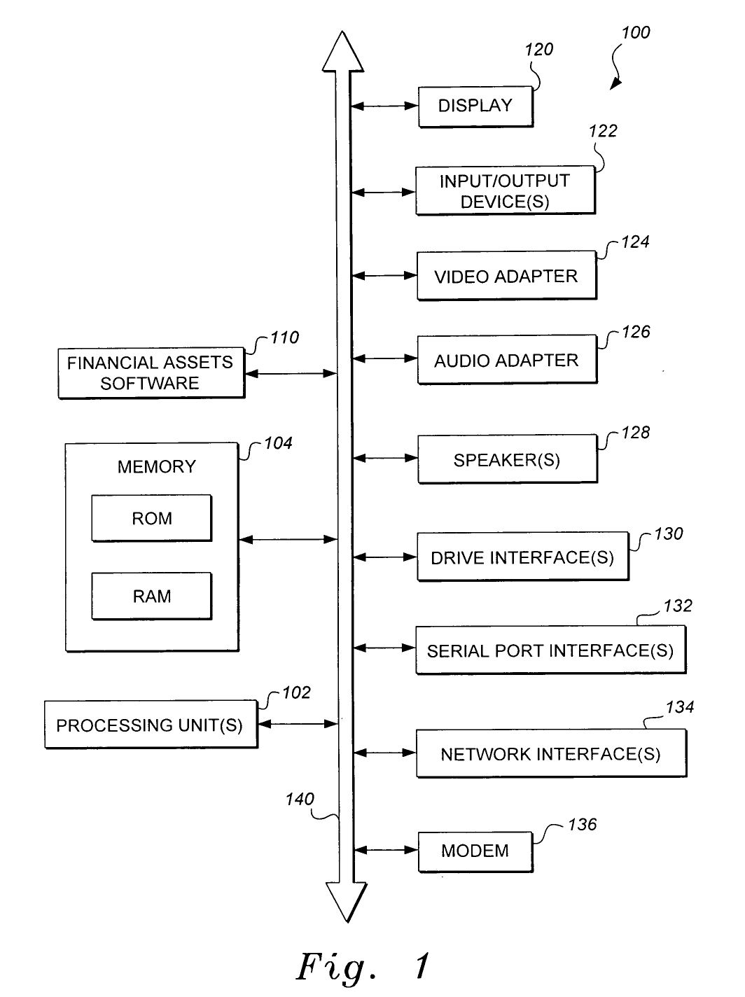

FIG. 1 shows a block diagram of a computing device 100 configured to utilize the ASSET FINANCIAL RESTRUCTURING software 110 according to the invention. The computing device 100 includes a processing unit(s) 102, memory 104, ASSET FINANCIAL RESTRUCTURING software 110, and a system bus 140 that operatively couples the memory and other system components to the processing unit(s) 102. The processing unit(s) 102 may be one or more processing units, such as a single central processing unit, or a plurality of processing units. The computing device 100 may be a conventional computer, a distributed computer, or any other type of computer. The computing device 100 may include a display 120, input/output device(s) 122, a video adapter 124, an audio adapter 126, speaker(s) 128, drive interface(s) 130, serial port interface(s) 132, network interface(s) 134, and a modem 136.

The system bus 140 can be any of several types, including a memory bus or memory controller, a peripheral bus, a local bus, etc., and can use any of a variety of bus architectures. The memory 104 may include read-only memory (ROM) and random-access memory (RAM). The ROM typically includes a basic input/output system (BIOS) stored therein. The BIOS contains the basic routines that transfer information between components of the computing device. The BIOS also contains start-up routines for the computing device 100.

The computing device 100 may include a hard disk drive with one or more magnetic hard disks onto which data is stored and retrieved for reading from and writing to the drive interface(s) 130, such as a hard disk drive interface, a magnetic disk drive for reading from and writing to a removable magnetic disk, and/or an optical disk drive for reading from and/or writing to a removable optical disk such as a CD-ROM, DVD or other optical medium. A hard disk drive, magnetic disk drive, and optical disk drive may be connected to the system bus by a hard-disk drive interface, a magnetic-disk drive interface, and an optical-drive interface, respectively. The drives and their associated computer useable media provide nonvolatile storage of computer useable instructions, data structures, program modules, and other data for the computing unit 100. While the computing device may employ a hard disk, a removable magnetic disk, and/or a removable optical disk, it is also well known to those skilled in the art that other types of computer useable media which can store data accessible by a computer can also be used. Such media may include magnetic tape cassettes, Flash memory cards, Bernoulli cartridges, and the like.

The ASSET FINANCIAL RESTRUCTURING software 110 includes a plurality of computer instructions and may be carried on any computer useable medium according to the desires of the user, such as a computer hard drive, a floppy disk, Flash memory, optical memory, magnetic media memory, or the like. A user can enter commands and information into the computing device 100 through input devices such as a keyboard and a pointing device. Other input devices may include a microphone, joystick, game pad, satellite dish, scanner, or the like. These and other input devices may be connected to the processing unit(s) 102 through the serial port interface(s) 132 coupled to the system bus 140, and they may also be connected through other interfaces not shown in FIG. 1, such as a parallel port, a game port, a universal serial bus interface, etc. The display 120 also connects to the system bus 140 via an interface such as the video adapter 124. One or more speakers 128 or other audio output transducers that are driven by the audio adapter 126 may be connected to the system bus 140. Peripheral output devices may also be connected to the system bus 140.

The computing device 140 may operate in a networked environment using logical connections to one or more remote computers. Such a remote computer may be another computing device 100, a server, a router, a network computer, a peer device, or other common network node. The remote computer may include any or all of the components described above in connection with computing device 100.

The computing device 100 is configured to logically interconnect to local-area network (LAN) and a wide-area network (WAN). Such networking environments are commonplace in offices, enterprise-wide computer networks, intranets, and the Internet.

When placed in a LAN networking environment, the computing device 100 connects to the local network through the network interface(s) 134. When used in a WAN networking environment such as the Internet, the computing device 100 establishes communications over the network using the modem 138. The modem 138 may be internal or external to the computing device 100 and may connect to the system bus 140 via the serial port interface 132.

The ASSET FINANCIAL RESTRUCTURING software 110 initially captures data for table driven formulas. Set-up data includes data associated with the fields USER NAME, USER COMPANY, DEFAULT PRESENT VALUE (PV) RATE, DEFAULT DEAL YIELD, DEFAULT RESIDUAL VALUE UPLIFT, and END OF TERM WARNING TERM.

Data for each asset is captured and stored. Asset data includes data associated with the fields ASSET TYPE, ASSET FLAG, DEAL DATE, PRICE, LEASE FLAG, DEAL TERM, DEAL PAYMENT (depreciation override), and DEAL MAINTENANCE. Other data may be associated with the fields ASSET MANUFACTURER, ASSET MODEL, ASSET NUMBER, CUSTOMER NAME, and ASSET QUANTITY.

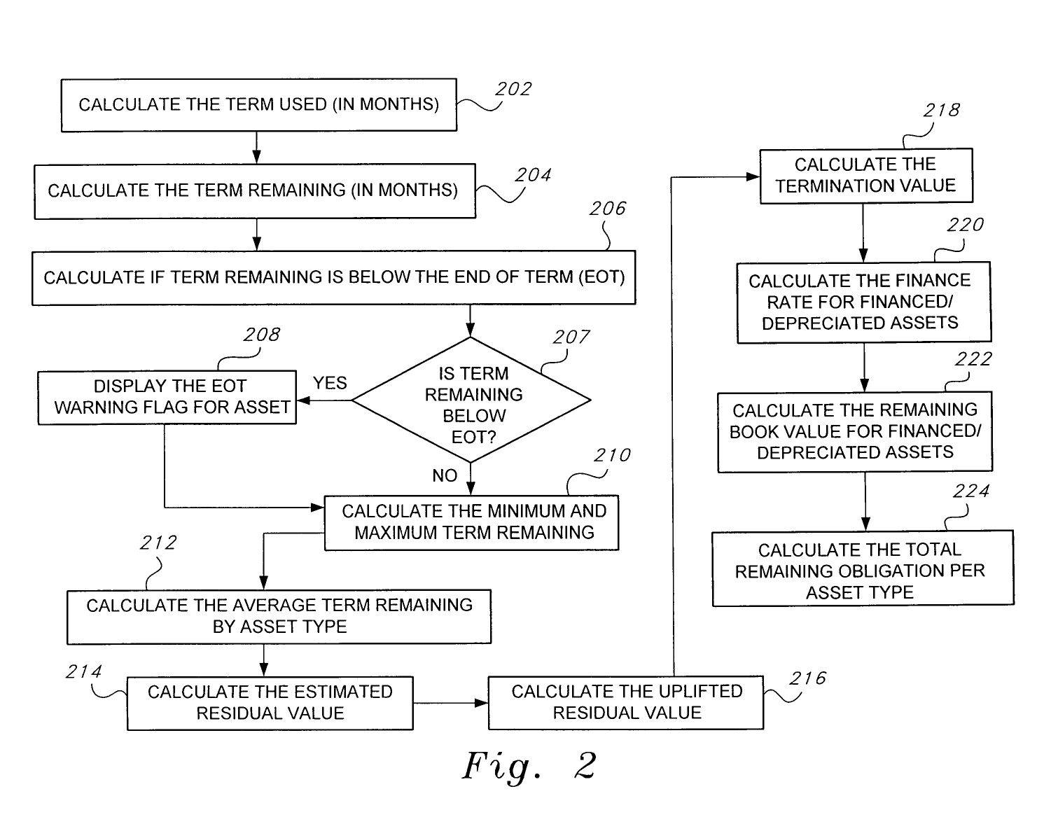

Referring to FIG. 2, the TERM USED in months of a technology lease is initially calculated for an asset (step 202). A determination is made as to how much of the original term of the technology lease has been used. The date the technology lease was executed is subtracted from the system date of the computing unit to produce a result in days. The result (in days) is then divided by thirty to obtain the TERM USED in months.

The amount of time remaining on the original lease term (TERM REMAINING) is determined in step 204 by subtracting the TERM USED from the original term of the technology lease (DEAL TERM) In step 206, the TERM USED is compared with a predetermined minimum end of term amount of time (END OF TERM (EOT)) to determine if the TERM USED is lower than the END OF TERM. If the TERM USED is lower than the END OF TERM (step 207) an EOT warning flag is set and an EOT warning is displayed on the display (step 208). The MINIMUM and MAXIMUM TERM REMAINING is determined for each asset type (step 210).

The calculated MINIMUM and MAXIMUM TERM REMAINING values for each asset type are stored for reporting and charting purposes. The AVERAGE TERM is then determined for each asset type (step 212) and the calculated AVERAGE TERM is stored for reporting and charting purposes. A present value function is executed to determine the ESTIMATED RESIDUAL VALUE (EST RV) for each leased asset (step 214). The present value function is based on the DEAL TERM, the DEAL YIELD divided by twelve, the PRICE, the DEAL PAYMENT (depreciation override), and PAYMENTS IN ADVANCE for the associated leased asset.

An uplifted residual value (UPLIFTED RV) is determined for each leased asset by multiplying the associated EST RV by an associated RV VALUE for the associated asset (step 216). A TERMINATION VALUE for each leased asset is determined (step 218). The TERMINATION VALUE is based on a present value function utilizing the TERM REMAINING, the present value rate divided by twelve, the DEAL PAYMENT (depreciation override), the UPLIFTED RV, and PAYMENTS IN ADVANCE for the associated leased asset.

The FINANCE RATE for financed and depreciated assets is then determined by utilizing a rate function (step 220). The rate function is based on the DEAL TERM, the PRICE, the DEAL PAYMENT (depreciation override), a FUTURE VALUE of zero, and payments in ARREARS for the associated asset. The REMAINING BOOK VALUE (RBV) is then determined for financed and depreciated assets. The RBV is based on a present value function utilizing the TERM REMAINING, the FINANCE RATE divided by twelve, the DEAL PAYMENT (depreciation override), a future value of zero, and payment in ARREARS for the associated asset. The TOTAL REMAINING OBLIGATION per asset type is then determined by adding the TERMINATION VALUE of the leased assets and the BOOK VALUE of the financed and depreciated assets.

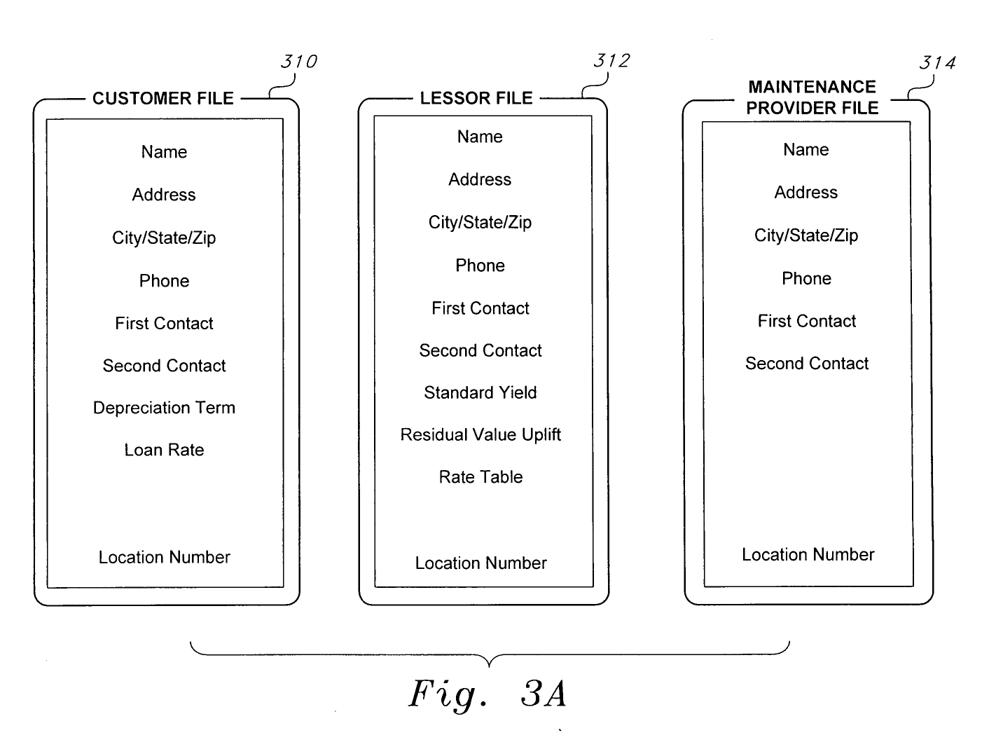

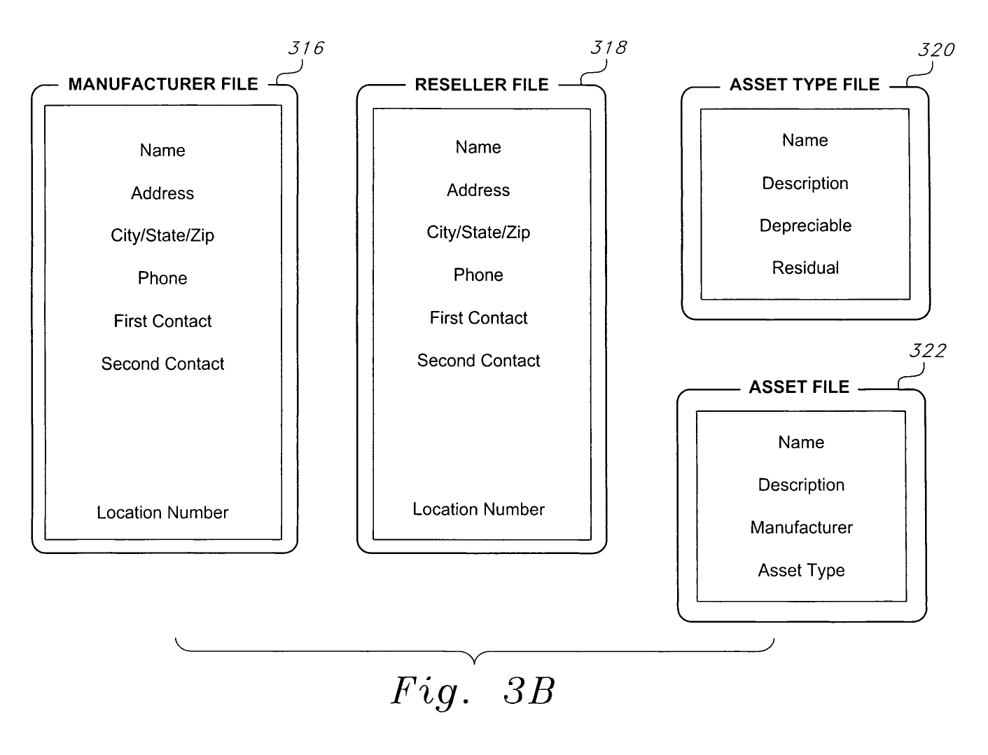

The ASSET FINANCIAL RESTRUCTURING software 110 utilizes primary data files, preliminary data, stored data, and manual input data. The primary data files include a Customer File 310, a Lessor File 312, a Maintenance Provider File 314, a Manufacturer File 316, a Reseller File 318, an Asset Type File 320, and an Asset File 322 (see FIGS. 3A and 3B).

As shown in FIG. 3A, the Customer File 310 includes data associated with the fields NAME, ADDRESS, CITY/STATE/ZIP, PHONE, FIRST CONTACT, SECOND CONTACT, DEPRECIATION TERM, and LOAN RATE. The Customer File 310 may also include data associated with the field LOCATION NUMBER. The Lessor File 312 includes data associated with the fields NAME, ADDRESS, CITY/STATE/ZIP, PHONE, FIRST CONTACT, SECOND CONTACT, STANDARD YIELD, REVENUE VALUE UPLIFT, and RATE TABLE. The Lessor File 312 may also include data associated with the field LOCATION NUMBER. The Maintenance Provider File 314 includes data associated with the fields NAME, ADDRESS, CITY/STATE/ZIP, PHONE, FIRST CONTACT, and SECOND CONTACT. The Customer File 314 may also include data associated with the field LOCATION NUMBER.

As shown in FIG. 3B, the Manufacturer File 316 includes data associated with the fields NAME, ADDRESS, CITY/STATE/ZIP, PHONE, FIRST CONTACT, and SECOND CONTACT. The Manufacturer File 316 may also include the field LOCATION NUMBER. The Reseller File 318 includes data associated with the fields NAME, ADDRESS, CITY/STATE/ZIP, PHONE, FIRST CONTACT, and SECOND CONTACT. The Reseller File 318 may also include data associated with the field LOCATION NUMBER. The Asset Type File 320 includes data associated with the fields NAME, DESCRIPTION, DEPRECIABLE, and RESIDUAL. The Asset File 322 includes data associated with the fields NAME, DESCRIPTION, MANUAFACTURER, and ASSET TYPE.

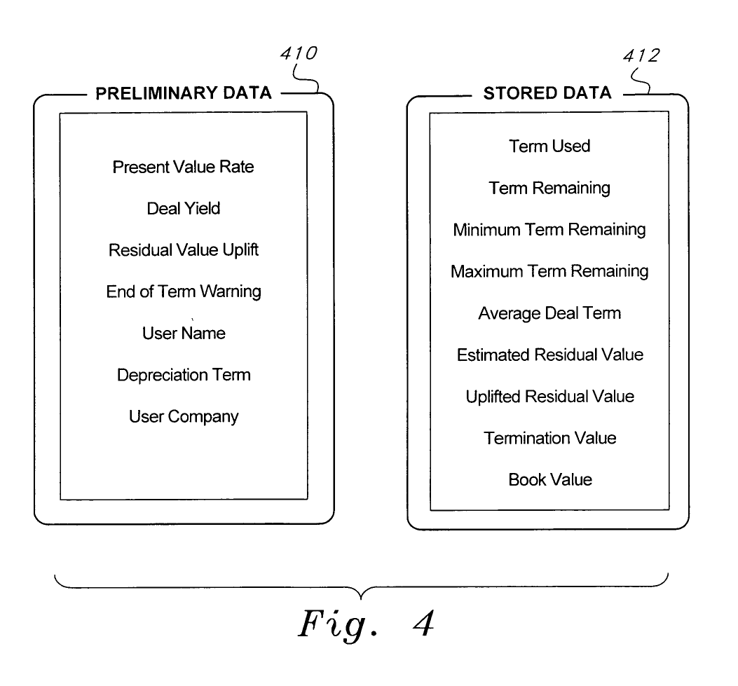

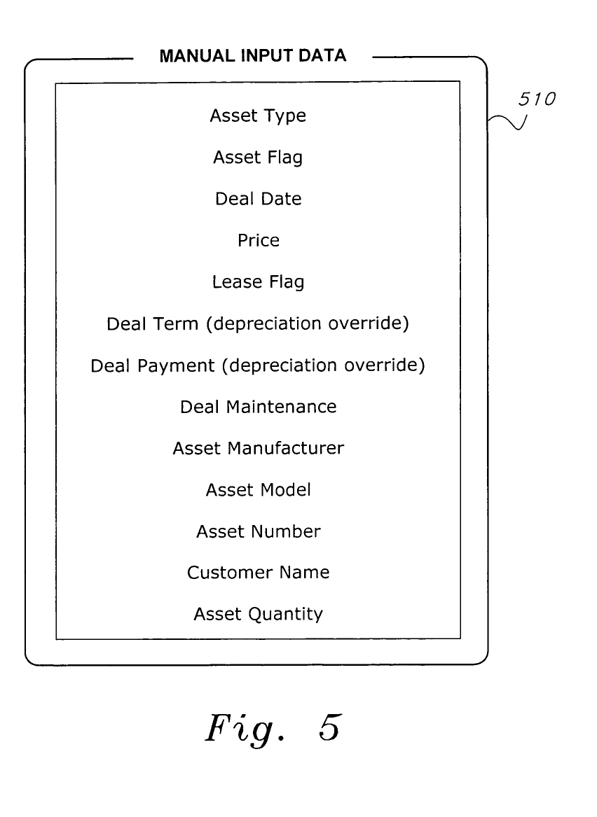

Referring to FIG. 4, the ASSET FINANCIAL RESTRUCTURING software 110 captures and stores Preliminary Data including data associated with the fields PRESENT VALUE RATE, DEAL YIELD, RESIDUAL VALUE UPLIFT, END OF TERM WARNING, USER NAME, DEPRECIATION TERM, and USER COMPANY. The stored data includes data associated with the fields TERM USED, TERM REMAINING, MINIMUM TERM REMAINING, MAXIMUM TERM REMAINING, AVERAGE DEAL TERM, ESTIMATED RESIDUAL VALUE, UPLIFTED RESIDUAL VALUE, TERMINATION VALUE, and BOOK VALUE. Manual input data 510, as shown in FIG. 5, includes data associated with the fields ASSET TYPE, ASSET FLAG, DEAL DATE, PRICE, LEASE FLAG, DEAL TERM, DEAL PAYMENT (depreciation override), DEAL MAINTENANCE, ASSET MANUFACTURER, ASSET MODEL, ASSET NUMBER, CUSTOMER NAME, and ASSET QUANTITY.

The ASSET FINANCIAL RESTRUCTURING software of the present invention can be used to determine the remaining book value of assets that are financed or depreciated. The ASSET FINANCIAL RESTRUCTURING software evaluates the financing method used when the asset is placed in service and adjusts the calculations to reflect the subtle but definite differences in finance type. For example, it is customary for technology leases to have payments made in advance (day one of the term) whereas finance payments are typically in arrears (last day of the term). Residual values are not part of a finance calculation since ownership transfers to the payee at the end of the term. The ASSET FINANCIAL RESTRUCTURING software uses a zero residual value in the calculations.

When used in tandem in a software application, the two methods of determining mid-term asset valuation provide real time termination values at any point in the financing term. This greatly simplifies the ability to determine termination costs when evaluating alternative approaches or strategies. With a heightened focus on financial transparency, businesses will look increasingly for capabilities such as this to remain in compliance with certain reporting requirements of the Sarbanes Oxley Act.

While the invention has been described with references to its preferred embodiment, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A method to determine remaining financial obligations of assets, said method comprising:
executing ASSET FINANCIAL RESTRUCTURING software;
utilizing data from primary data files;
utilizing data from preliminary data;
utilizing data from stored data;
utilizing data that is input manually; and
determining the remaining financial obligation value of leased assets and the book value of financed or depreciated assets.

2. The method according to claim 1, wherein the utilizing data from primary data files step further comprises utilizing data from a Customer File, a Lessor File, a Maintenance Provider File, a Manufacturer File, a Reseller File, an Asset Type File, and an Asset File.

3. The method according to claim 1, wherein the utilizing data from preliminary data step further comprises utilizing data from a data associated with the fields PRESENT VALUE RATE, DEAL YIELD, RESIDUAL VALUE UPLIFT, END OF TERM WARNING, USER NAME, DEPRECIATION TERM, and USER COMPANY.

4. The method according to claim 1, wherein the utilizing data from stored data step further comprises utilizing data associated with fields TERM USED, TERM REMAINING, MINIMUM TERM REMAINING, MAXIMUM TERM REMAINING, AVERAGE DEAL TERM, ESTIMATED RESIDUAL VALUE, UPLIFTED RESIDUAL VALUE, TERMINATION VALUE, and BOOK VALUE.

5. The method according to claim 1, wherein the utilizing data that is input manually further comprises utilizing data associated with fields ASSET TYPE, ASSET FLAG, DEAL DATE, PRICE, LEASE FLAG, DEAL TERM, DEAL PAYMENT (depreciation override), DEAL MAINTENANCE, ASSET MANUFACTURER, ASSET MODEL, ASSET NUMBER, CUSTOMER NAME, and ASSET QUANTITY.

6. The method according to claim 1, wherein the determining the remaining book value of assets that are financed or depreciated step further comprises determining a TERM USED in months for an asset;
determining a TERM REMAINING for an asset;
determining a MINIMUM and MAXIMUM TERM REMAINING for the asset;
determining an AVERAGE TERM for the asset;
determining an ESTIMATED RESIDUAL VALUE for the asset;
determining an UPLIFTED RV for the asset;
determining a TERMINATION VALUE for the asset;
determining a FINANCE RATE for a the asset;
determining a REMAINING BOOK VALUE for the asset; and
determining a TOTAL REMAINING OBLIGATION for the asset.

7. An ASSET FINANCIAL RESTRUCTURING software system to determine the remaining financial obligation value of assets, said system comprising:
a computer useable medium; and
a computer device having a processing unit;
wherein said computer useable medium carries thereon ASSET FINANCIAL RESTRUCTURING software, which, when executed by the processing unit, causes the processing unit to carry out steps comprising:
executing the ASSET FINANCIAL RESTRUCTURING software;
utilizing data from primary data files;
utilizing data from preliminary data;
utilizing data from stored data;
utilizing data that is input manually; and
determining the remaining financial obligation value of leased assets and the book value of financed or depreciated assets.

8. The system according to claim 7, wherein said utilizing data from primary data files step further comprises utilizing data from a Customer File, a Lessor File, a Maintenance Provider File, a Manufacturer File, a Reseller File, an Asset Type File, and an Asset File.

9. The system according to claim 7, wherein said utilizing data from preliminary data step further comprises utilizing data from a data associated with the fields PRESENT VALUE RATE, DEAL YIELD, RESIDUAL VALUE UPLIFT, END OF TERM WARNING, USER NAME, DEPRECIATION TERM, and USER COMPANY.

10. The system according to claim 7, wherein said utilizing data from stored data step further comprises utilizing data associated with fields TERM USED, TERM REMAINING, MINIMUM TERM REMAINING, MAXIMUM TERM REMAINING, AVERAGE DEAL TERM, ESTIMATED RESIDUAL VALUE, UPLIFTED RESIDUAL VALUE, TERMINATION VALUE, and BOOK VALUE.

11. The system according to claim 7, wherein said utilizing data that is input manually further comprises utilizing data associated with fields ASSET TYPE, ASSET FLAG, DEAL DATE, PRICE, LEASE FLAG, DEAL TERM, DEAL PAYMENT (depreciation override), DEAL MAINTENANCE, ASSET MANUFACTURER, ASSET MODEL, ASSET NUMBER, CUSTOMER NAME, and ASSET QUANTITY.

12. The system according to claim 7, wherein said determining the remaining book value of assets that are financed or depreciated step further comprises:
determining a TERM USED in months for an asset;
determining a TERM REMAINING for the asset;
determining a MINIMUM and MAXIMUM TERM REMAINING for the asset;
determining an AVERAGE TERM for the asset;
determining an ESTIMATED RESIDUAL VALUE for the asset;
determining an UPLIFTED RV for the asset;
determining a TERMINATION VALUE for the asset;
determining a FINANCE RATE for the asset;
determining a REMAINING BOOK VALUE the asset; and
determining a TOTAL REMAINING OBLIGATION for the asset.

13. The system according to claim 12, wherein said determining a TERM REMAINING for a leased asset further comprises comparing the TERM USED with an END OF TERM (EOT), and displaying an EOT warning on a display if the TERM USED is lower than the END OF TERM.

14. A computer useable medium carrying ASSET FINANCIAL RESTRUCTURING software which, when executed by a processing unit, causes the processing unit to carry out steps comprising:
utilizing data from primary data files;
utilizing data from preliminary data;
utilizing data from stored data;
utilizing data that is input manually; and
determining the remaining financial obligation value of leased assets and the book value of financed or depreciated assets.

15. The computer useable medium according to claim 14, wherein said utilizing data from primary data files step further comprises utilizing data from a Customer File, a Lessor File, a Maintenance Provider File, a Manufacturer File, a Reseller File, an Asset Type File, and an Asset File.

16. The computer useable medium according to claim 14, wherein said utilizing data from preliminary data step further comprises utilizing data from a data associated with the fields PRESENT VALUE RATE, DEAL YIELD, RESIDUAL VALUE UPLIFT, END OF TERM WARNING, USER NAME, DEPRECIATION TERM, and USER COMPANY.

17. The computer useable medium according to claim 14, wherein said utilizing data from stored data step further comprises utilizing data associated with fields TERM USED, TERM REMAINING, MINIMUM TERM REMAINING, MAXIMUM TERM REMAINING, AVERAGE DEAL TERM, ESTIMATED RESIDUAL VALUE, UPLIFTED RESIDUAL VALUE, TERMINATION VALUE, and BOOK VALUE.

18. The computer useable medium according to claim 14, wherein said utilizing data that is input manually further comprises utilizing data associated with fields ASSET TYPE, ASSET FLAG, DEAL DATE, PRICE, LEASE FLAG, DEAL TERM, DEAL PAYMENT (depreciation override), DEAL MAINTENANCE, ASSET MANUFACTURER, ASSET MODEL, ASSET NUMBER, CUSTOMER NAME, and ASSET QUANTITY.

19. The computer useable medium according to claim 14, wherein said determining the remaining book value of assets that are financed or depreciated step further comprises:
determining a TERM USED in months for an asset;
determining a TERM REMAINING for the asset;
determining a MINIMUM and MAXIMUM TERM REMAINING for the asset;
determining an AVERAGE TERM for the asset;
determining an ESTIMATED RESIDUAL VALUE for the asset;
determining an UPLIFTED RV for the asset;
determining a TERMINATION VALUE for the asset;
determining a FINANCE RATE for the asset;
determining a REMAINING BOOK VALUE for the asset; and
determining a TOTAL REMAINING OBLIGATION for the asset.

20. The computer useable medium according to claim 7, wherein said determining a TERM REMAINING for the asset further comprises comparing the TERM USED with an END OF TERM, and displaying an EOT warning on a display if the TERM USED is lower than the END OF TERM.
